(19) United States
(12) Patent Application Publication
(10) Pub. No.: US 2009/0243989 A1
(43) Pub. Date: Oct. 1, 2009

(54) DISPLAY APPARATUS

(76) Inventors: Sang-Keun LEE, Seoul (KR); Seung-Hwan Moon, Yongin-si (KR); Ki-Chan Lee, Cheonan-si (KR); Kyung-Uk Chio, Asan-si (KR)

Correspondence Address: Haynes and Boone, LLP;IP Section, 2323 Victory Avenue, SUITE 700, Dallas, TX, 75219, US

(21) Appl. No.: 12/259,206

(22) Filed: Oct. 27, 2008

(30) Foreign Application Priority Data
Apr. 1, 2008 (KR) 2008-0030430

(51) Int. Cl. G09G 3/36

(52) U.S. Cl. 345/98

(57) ABSTRACT

A display apparatus that includes a controller, a gate driver, a data driver, and a gamma voltage generator is presented. The controller generates image data and a data clock to drive a display unit based on original data and an original control signal received from an exterior. The gate driver provides an image data signal to a data interconnection provided in the display unit. The data driver provides a gate signal to a gate interconnection provided in the display unit. The gamma voltage generator generates gamma voltages serving as a reference in response to the data driver providing the gate signal to the display unit. The gamma voltage generator selectively outputs sub-reference voltages, which are divided from an external reference voltage, and a specific voltage, which is generated from the gamma voltage generator, as the gamma voltages.

### CROSS-REFERENCE TO RELATED APPLICATIONS

This application claims priority to and benefit of Korean Patent Application No. 2008-30430, filed on Apr. 1, 2008, the contents of which are herein incorporated by reference in their entirety.

### BACKGROUND

1. Technical Field

The present invention relates to a display apparatus, and more particularly, to a display apparatus capable of generating a gamma voltage serving as a reference for data displayed as an image.

2. Related Art

From among display apparatuses, an LCD (liquid crystal display) has advantages of slimness, lightweight and low power consumption as compared with a CRT (cathode ray tube). In particular, an LCD having a TFT (thin film transistor) displays information with high resolution and achieves performance substantially similar to that of the CRT.

A typical LCD includes a liquid crystal panel that displays an image in response to gate and data voltages, a gate driver that outputs the gate voltage to the liquid crystal panel, and a data driver that provides the data voltage to the liquid crystal panel by using a gamma voltage. The LCD may include a gamma voltage generator that generates the gamma voltage to provide the data driver with the gamma voltage.

The LCD uses an analog gamma voltage as a reference voltage used to display data. The data driver generates the data voltage corresponding to the data by using the gamma voltage and provides the data voltage to the liquid crystal panel. In one aspect, a plurality of liquid crystals included in the liquid crystal panel are shifted by the data voltage output from the data driver to display the image.

The conventional gamma voltage generator that generates the gamma voltage includes a plurality of resistors serially connected between an analog supply voltage and a ground voltage. The gamma voltage generator generates a plurality of gamma voltages divided from the analog supply voltage through nodes between adjacent resistors.

However, if resistance values of the resistors vary depending on a temperature increase and the like, an abnormal gamma voltage is generated from the gamma voltage generator. In such a case, tuning of the gamma voltage is performed by changing the resistance values of the resistors. However, since the resistors used in the gamma voltage generator have fixed resistance values, the tuning of the gamma voltage is not available.

Moreover, if an abnormal analog supply voltage (e.g., an analog supply voltage having ripple components) is applied to the resistors, the gamma voltage generator outputs a plurality of abnormal gamma voltages through the nodes between the adjacent resistors.

Thus, the abnormal gamma voltages generated from the gamma voltage generator degrades the display quality of an LCD. Accordingly, an improved gamma voltage generator is needed to manage abnormal gamma voltages without degrading the display quality of an LCD.

### SUMMARY

In accordance with one or more embodiments of the present disclosure, a display apparatus is provided that is adapted to and capable of inhibiting the display quality from being degraded by abnormal gamma voltage.

In an exemplary embodiment of the present disclosure, a display apparatus includes a controller, a gate driver, a data driver, and a gamma voltage generator. The controller generates image data and a data clock to drive a display unit based on original data and an original control signal received from an exterior. The gate driver provides an image data signal to a data interconnection provided in the display unit. The data driver provides a gate signal to a gate interconnection provided in the display unit. The gamma voltage generator generates gamma voltages serving as a reference which is necessary when the data driver provides the signal to the display unit. The gamma voltage generator selectively outputs sub-reference voltages, which are divided from an external reference voltage, and a specific voltage, which is generated from the gamma voltage generator, as the gamma voltages.

In one embodiment, the gamma voltage generator includes a data receiver, a plurality of registers, a digital-analog converter, and a voltage setting unit. The data receiver receives digital reference data serving as a reference of gamma voltages and reference data clocks. The registers store the reference data received in the data receiver. The digital-analog converter converts the reference data stored in the resistor array to analog-type first and second gamma voltages to output the analog-type first and second gamma voltages. The voltage setting unit outputs third gamma voltages by receiving sub-reference voltages. In one implementation, the voltage setting unit selectively outputs the received sub-reference voltages or specific voltages having a predetermined level.

In one embodiment, the voltage setting unit includes a counter, a resistor array, a first switching unit, a second switching unit, and a switching controller. The counter counts a number of the reference data clocks. The resistor array has a plurality of resistors serially connected between a reference voltage and a ground voltage. The first switching unit has a first end, which is connected to one connection node connecting the resistors in the resistor array to each other, and a second end connected to an output terminal of the voltage setting unit, the first end being opposite to the second end. The second switching unit has a first end connected to the sub-reference voltage, and a second end connected to the output terminal of the voltage setting unit, the first end being opposite to the second end. The switching controller outputs control signals, which are used to control the first and second switching units, by receiving a counting value output from the counter. The display apparatus includes a level shifter that increases a voltage level of the control signal output from the switching controller.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a block diagram illustrating an exemplary embodiment of a display apparatus according to the present disclosure;

FIG. 2 is a block diagram illustrating a gamma voltage generator shown in FIG. 1;

FIG. 3 is a block diagram illustrating a voltage setting unit shown in FIG. 2; and

FIG. 4 is a graph illustrating waveforms of a third gamma voltage output from a voltage setting unit.

### DETAILED DESCRIPTION OF EMBODIMENTS

Hereinafter, in accordance with one or more embodiments of the present disclosure, a display apparatus is described with reference to the accompanying drawings.

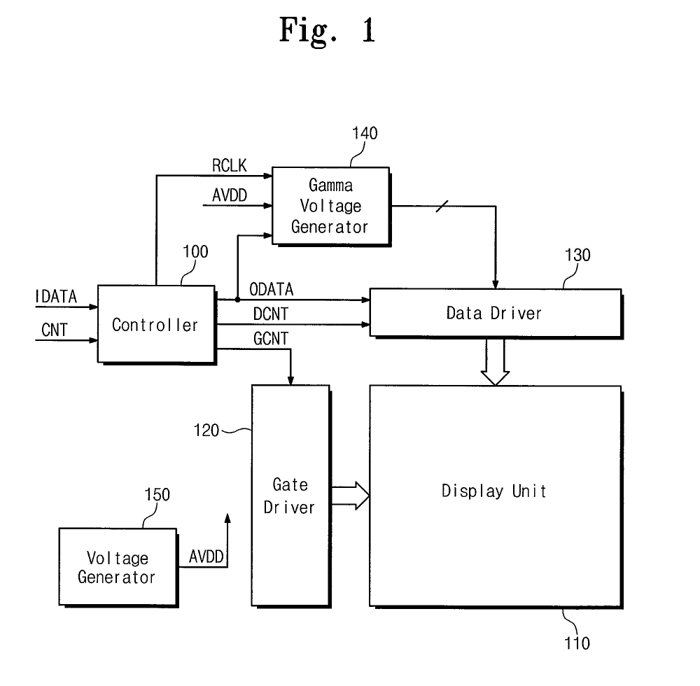

FIG. 1 is a block diagram illustrating an exemplary embodiment of a display apparatus, in accordance with the present disclosure. Referring to FIG. 1, the display apparatus includes a controller 100, a display unit 110, a gate driver 120, a data driver 130 and a gamma voltage generator 140. Further, the display apparatus further includes a voltage generator 150.

The controller 100, in one embodiment, generates output image data ODATA, a gate control signal GCNT, and a data control signal DCNT, which are used to drive the display unit 110, in response to input image data IDATA and an input control signal CNT received from an external system (not shown). In one aspect, the controller 100 outputs the output image data ODATA to the gamma voltage generator 140 as reference data. In another aspect, the controller 100 generates a reference data clock RCLK to output the reference data clock RCLK to the gamma voltage generator 140. The controller 100 may include a clock generator (not shown) to generate the reference data clock RCLK.

The input image data IDATA and the original control signal CNT may be provided from a graphic card (not shown) of a personal computer (PC) and the like, and correspond to digital signals including at least one data bit having a logic value of 0 or 1.

The display unit 110, in one embodiment, includes a flat display panel that displays an image corresponding to the output image data ODATA. In one aspect, the present exemplary embodiment comprises a liquid crystal panel (not shown). However, the scope of the present disclosure is not limited thereto.

The liquid crystal panel, in one embodiment, includes a plurality of gate interconnections and a plurality of data interconnections insulated from each other while crossing each other. A plurality of pixel areas arranged in a matrix type are defined by the gate and data interconnections. Each pixel area includes at least one pixel. Thus, the liquid crystal panel includes a plurality of pixels arranged in a matrix type. Each pixel is electrically connected to the gate and data interconnections. Thus, a gate voltage is provided to the pixel through the gate interconnections and a data voltage is provided to the pixel through the data interconnections.

The pixel, in one embodiment, includes a TFT (not shown) electrically connected to the gate and data interconnections, and a liquid crystal capacitor (not shown) electrically connected to the TFT. The liquid crystal capacitor includes a first electrode, a second electrode and a liquid crystal. If the gate voltage is applied to the TFT, the TFT is turned on and the data voltage is applied to the first electrode. A common voltage having a level lower than that of the data voltage is applied to the second electrode, so that an electric field is formed between the first and second electrodes. The liquid crystal adjusts the amount of transmitted light according to the intensity of the electric field.

In one embodiment, the display unit 110 is electrically connected to a data driver 130 that provides the data voltage to the data interconnections, and a gate driver 120 that provides the gate voltage to the gate interconnections. For example, the data driver 130 may be electrically connected to the liquid crystal panel through a tap carrier package, and the gate driver 120 may be integrated on the liquid crystal panel. In another example, the data driver 130 may be integrated on the liquid crystal panel, and the gate driver 120 may be electrically connected to the liquid crystal panel through the tap carrier package. In one implementation, the data driver 130 and the gate driver 120 may be mounted on the liquid crystal panel in the form of a chip.

In one embodiment, the gate driver 120 sequentially applies gate on and off voltages to the gate interconnections in response to the gate control signal GCNT provided from the controller 100 and a gate voltage GV provided from the voltage generator 150.

The data driver 130, in one embodiment, generates the data voltage in response to plural gamma voltages from the gamma voltage generator 140 and the output image data from the controller 100. The data driver 130 selects a gamma voltage matched with the output image data to generate the data voltage from the selected gamma voltage. The gamma voltages provided from the gamma voltage generator 140 are subdivided by a plurality of resistors. Thus, the data driver 130 generates the data voltage, which is output to the display unit 110, based on the subdivided gamma voltages. The data voltage is applied to corresponding pixels included in the display unit 110 so that the corresponding pixels display an image corresponding to the data voltage. The output image data corresponds to a digital signal and the gamma voltage corresponds to an analog signal.

The gamma voltage generator 140, in one embodiment, generates the gamma voltages by receiving the reference data block, reference voltage AVDD, and reference data. The reference data is identical to the output image data ODATA. Thus, the output image data ODATA input to the gamma voltage generator 140 may be referred to as reference data ODATA, unless specially mentioned otherwise. The gamma voltage generator 140 is described in greater detail herein.

The voltage generator 150, in one embodiment, generates the reference voltage AVDD by receiving a general AC supply voltage VIN from the external system. In one implementation, although not shown in FIG. 1, the voltage generator 150 may include an AC-DC rectifier (not shown) and a DC-DC converter (not shown).

The AC-DC rectifier, in one embodiment, converts the general AC supply voltage VIN to high DC voltage by using a power factor correction function. The DC-DC converter generates the reference voltage AVDD by converting a level of the high DC voltage provided from the AC-DC rectifier.

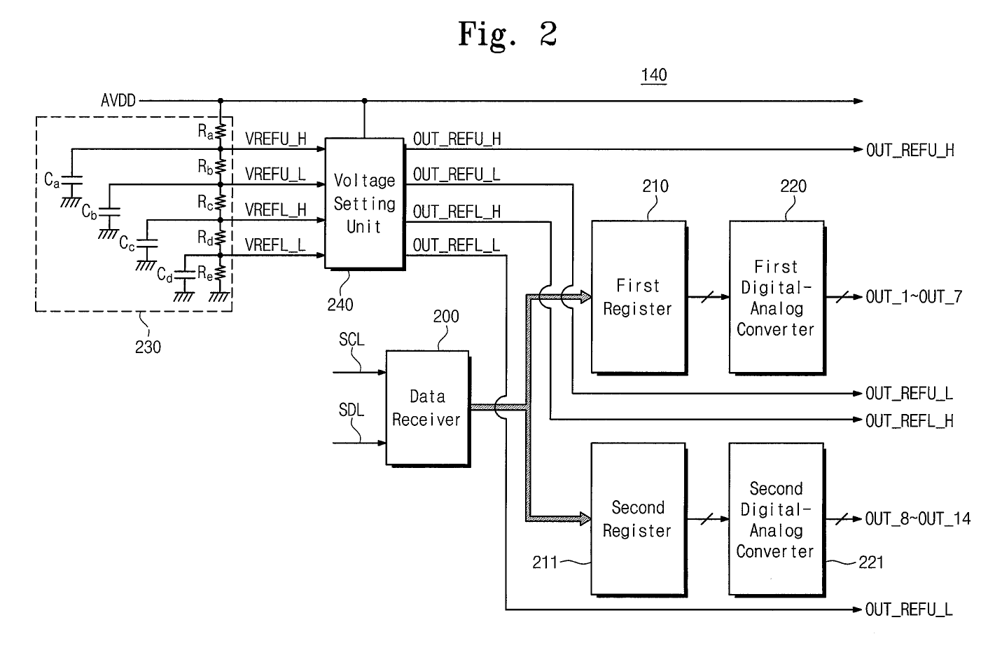

Hereinafter, in accordance with one or more embodiments of the present disclosure, the gamma voltage generator 140 is described in detail with reference to FIG. 2.

FIG. 2 is a block diagram illustrating one embodiment of the gamma voltage generator 140, as shown in reference to FIG. 1. Referring to FIG. 2, the gamma voltage generator 140 includes a data receiver 200, a register unit, a digital-analog conversion unit, a sub-reference voltage generator 230, and a voltage setting unit 240.

The data receiver 200, in one embodiment, receives the reference data ODATA serving as a reference for the gamma voltage and the reference data clock RCLK from the controller 100. For example, the gamma voltage generator 140 and the controller 100 perform data communication therebetween through an interface using an I2C (inter-integrated circuit) protocol. Such an I2C communication method may change a function by software without changing hardware and support a communication function of one-to-many devices. In one aspect, the I2C is highly resistant to noise, has a high reliability, uses very low power and supports various voltage levels. The I2C communication method uses two lines (i.e., a serial data (SDA) line and a serial clock (SCL) line).

The data receiver 200, in one embodiment, receives the reference data serving as a reference of the gamma voltage from the controller 100 through the SDA line and receives the reference data clock RCLK regarding the reference data from the controller 100 through the SCL line. However, an interface between the gamma voltage generator 140 and the controller 100 is not limited to the I2C protocol. In one aspect, various interfaces may be used if they transmit the reference data and the reference data clock. Since the reference data is used to generate the gamma voltage, the reference data may comprise one voltage value.

The register unit, in one embodiment, includes a first register 210 and a second register 211. The reference data ODATA received in the data receiver 200 is stored in the first and second registers 210 and 211. Since the values stored in the first and second registers 210 and 211 are digital values serving as a reference of the gamma voltage, the values stored in the first and second registers 210 and 211 may be symmetrical to each other about a specific voltage.

In one aspect, if an electric field having the same polarity is continuously applied to the liquid crystals included in the display unit 110, the liquid crystals may deteriorate. As such, the polarity of the electric field applied to the liquid crystals should be changed in a predetermined interval. Thus, the voltage values of data stored in the first and second registers 210 and 211 may be symmetrical to each other about the specific voltage so that the electric field having different polarities may be applied to the liquid crystals in the predetermined interval.

The digital-analog conversion unit, in one embodiment, includes a first digital-analog converter 220 and a second digital-analog converter 221. The first and second digital-analog converters 220 and 221 receive the digital reference voltage stored in the first and second registers 210 and 211 and convert the digital reference voltage to analog voltage. Since the data driver 130 receives the digital image data from the controller 100 and outputs the analog data voltage to the display unit 110 with reference to the analog-type gamma voltage, the digital voltage stored in the first and second registers 210 and 211 may not be used in the data driver 130 before the digital voltage is converted to the analog voltage. In one aspect, the first and second digital-analog converters 220 and 221 output a plurality of analog-type first analog gamma voltages OUT_1 to OUT_7 and a plurality of analog-type second gamma voltages OUT_8 to OUT_14, respectively. In another aspect, levels of the first gamma voltages OUT_1 to OUT_7 output from the first digital-analog converter 220 may be greater than that of the second gamma voltage OUT_8 having the highest level of the second gamma voltages OUT_8 to OUT_14 output from the second digital-analog converter 221.

The sub-reference voltage generator 230, in one embodiment, generates a plurality of sub-reference voltages VREFU_H, VREFU_L, VREFL_H and VREFL_L by receiving the reference voltage AVDD and the reference data clock RCLK from the voltage generator 150 and the controller 100, respectively. In one aspect, the sub-reference voltage generator 230 includes a plurality of resistors Ra, Rb, Rc, Rd and Re and a plurality of capacitors Ca, Cb, Cc, and Cd. The resistors Ra, Rb, Rc, Rd, and Re are serially connected between the reference voltage AVDD and the ground. One end of the capacitor Ca is connected between the resistors Ra and Rb, one end of the capacitor Cb is connected between the resistors Rb and Rc, one end of the capacitor Cc is connected between the resistors Rc and Rd, and one end of the capacitor Cd is connected between the resistors Rd and Re. The other ends of the capacitors Ca, Cb, Cc, and Cd are grounded. The reference voltage AVDD is divided into the sub-reference voltages VREFU_H, VREFU_L, VREFL_H and VREFL_L according to the resistors Ra, Rb, Rc, Rd and Re.

As described herein, the reference voltage AVDD is generated by the DC-DC converter included in the voltage generator 150, as shown in FIG. 1. The DC-DC converter generates the reference voltage AVDD by boosting the DC voltage output from the AC-DC rectifier. At this time, if ripples occur when boosting the DC voltage, output of the reference voltage AVDD may be unstable due to the ripples.

In this regard, to reduce the ripples, the capacitor Ca is connected to a connection node between the resistors Ra and Rb, the capacitor Cb is connected to a connection node between the resistors Rb and Rc, the capacitor Cc is connected to a connection node between the resistors Rc and Rd, and the capacitor Cd is connected to a connection node between the resistors Rd and Re. Accordingly, the ripples are discharged through the capacitors Ca, Cb, Cc, and Cd. At this time, in the case of employing the capacitors Ca, Cb, Cc, and Cd having excessively large capacities, signal delay may occur. In one aspect, the present disclosure utilizes the capacitors Ca, Cb, Cc, and Cd having capacities to the extent that they do not cause the signal delay.

The voltage setting unit 240, in one embodiment, receives the sub-reference voltages VREFU_H, VREFU_L, VREFL_H and VREFL_L from the sub-reference voltage generator 230 and outputs a plurality of third gamma voltages OUT_REFU_H, OUT_REFU_L, OUT_REFL_H and OUT_REFL_L. In one aspect, the third gamma voltages OUT_REFU_H, OUT_REFU_L, OUT_REFL_H and OUT_REFL_L are analog voltages. The third gamma voltage OUT_REFU_H has a level greater than that of the first gamma voltage OUT_1 having the highest level of the first gamma voltages OUT_1 to OUT_7 output from the first digital-analog converter 220. The third gamma voltage OUT_REFU_L has a level lower than that of the first gamma voltage OUT_7 having the lowest level of the first gamma voltages OUT_1 to OUT_7. The third gamma voltage OUT_REFL_H has a level greater than that of the second gamma voltage OUT_8 having the highest level of the second gamma voltages OUT_8 to OUT_14 output from the second digital-analog converter 221. The third gamma voltage OUT_REFL_L has a level lower than that of the second gamma voltage OUT_14 having the lowest level of the second gamma voltages OUT_8 to OUT_14. The third gamma voltage OUT_REFU_L has a level greater than that of the third gamma voltage OUT_REFL_H.

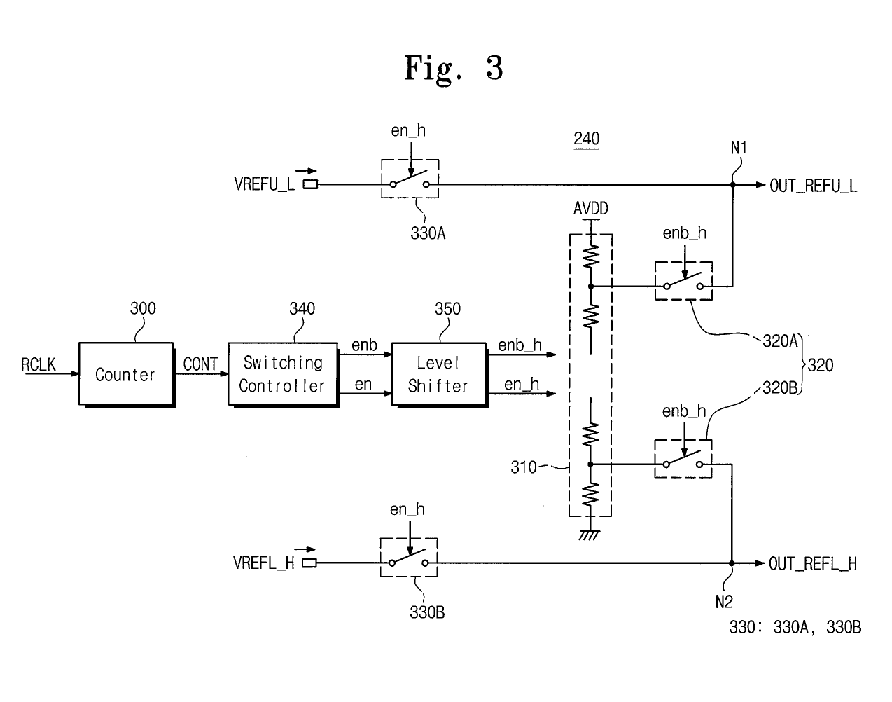

FIG. 3 is a block diagram illustrating one embodiment of the voltage setting unit 240, as shown in reference to FIG. 2. Referring to FIG. 3, the voltage setting unit 240 includes a counter 300, a switching controller 340, a level shifter 350, a resistor array 310, a first switching unit 320 and a second switching unit 330.

The counter 300, in one embodiment, is connected to the serial clock line to receive the reference data clocks RCLK from the controller 100. Then, the counter 300 counts the number of the reference data clocks RCLK to output a counting value CONT based on the counted number. T he resistor array 310 includes a plurality of resistors serially connected between the reference voltage AVDD and the ground.

The first switching unit 320, in one embodiment, includes a first switching circuit 320A and a second switching circuit 320B. The first switching circuit 320A is connected between one of the connection nodes among the resistors included in the resistor array 310 and a first output terminal N1 of the voltage setting unit 240. The second switching circuit 320B, in one embodiment, is connected between another one of the connection nodes among the resistors included in the resistor array 310 and a second output terminal N2 of the voltage setting unit 240. The second switching unit 330 includes a third switching circuit 330A and a fourth switching circuit 330B. The third switching circuit 330A, in one embodiment, is connected between the sub-reference voltage VREFU_L of the sub-reference voltages VREFU_H, VREFU_L, VREFL_H and VREFL_L and the first output terminal N1. The fourth switching circuit 330B, in one embodiment, is connected between the sub-reference voltage VREFL_H of the sub-reference voltages VREFU_H, VREFU_L, VREFL_H and VREFL_L and the second output terminal N2.

The switching controller 340, in one embodiment, receives the counting value CONT from the counter 300 to output control signals “enb” and “en” used to control switching operations of the first and second switching units 320 and 330. If the counting value CONT is smaller than a predetermined value (i.e., if the number of the reference data clocks RCLK is smaller than the predetermined number of clocks), the switching controller 340 outputs the control signals “enb” and “en” used to turn on the first switching unit 320 and turn off the second switching unit 330, respectively,

In one aspect, it may be assumed that the first switching unit 320 is turned on in response to the control signal “enb” having a high level and turned off in response to the control signal “enb” having a low level. Similarly to this, it may be assumed that the second switching unit 330 is turned on in response to the control signal “en” having a high level and turned off in response to the control signal “en” having a low level. In another aspect, the switching controller 340 may include a comparison circuit (not shown) that compares the counting value with the predetermined value. In various implementations, the predetermined value may be variously set by a system designer.

The level shifter 350, in one embodiment, increases voltage levels of the control signals “enb” and “en” output from the switching controller 340. Since the voltage levels of the control signals “enb” and “en” output from the switching controller 340 are not enough to turn on the first and second switching units 320 and 330, the voltage levels of the control signals “enb” and “en” are increased through the level shifter 350. The control signals “enb_h” and “en_h” having the increased voltage levels control turning on/off of the first and second switching units 320 and 330. In one aspect, the control signal “enb_h” controls the first switching unit 320 and the control signal “en_h” controls the second switching unit 330. For example, if the counting value CONT output from the counter 300 represents the number of clocks smaller than the predetermined value, the control signal “enb_h” is set to a high level and the control signal “en_h” is set to a low level. Thus, the first switching unit 320 is turned on and the second switching unit 330 is turned off.

In one embodiment, referring to the voltage generator 150 of FIG. 1, the reference voltage AVDD is substantially set to a level of a target voltage, but the sub-reference voltages VREFU_H, VREFU_L, VREFL_H and VREFL_L, which are divided from the reference voltage AVDD, reach the level of the target voltage after a predetermined time lapses. In one aspect, time difference occurs between the reference voltage AVDD and the sub-reference voltages VREFU_H, VREFU_L, VREFL_H and VREFL_L. In the case of using the capacitors Ca, Cb, Cc, and Cd, as shown in FIG. 2, to reduce the ripples contained in the reference voltage AVDD, delay between signals may be increased. As such, time difference between the reference voltage AVDD and the sub-reference voltages VREFU_H, VREFU_L, VREFL_H and VREFL_L may be increased.

In various implementations, before a predetermined time, when the first switching unit 320 connected to the resistor array 310 is turned on, voltages divided from the reference voltage AVDD are output to the output terminals N1 and N2 of the voltage setting unit 240. When the second switching unit 330 is turned off, the sub-reference voltages VREFU_L and VREFL_H are not input to the voltage setting unit 240. The voltage output through the first switching unit 320 may have the same level as that of the voltage output through the second switching unit 330 connected to the output terminals to which the first switching unit 320 is connected. After the predetermined time, when the first switching unit 320 connected to the resistor array 310 is turned off, the voltages divided from the reference voltage AVDD are not output. As such, when the second switching unit 330 is turned on, the sub-reference voltages VREFU_H and VREFL_H are input to the voltage setting unit 240.

In this way, time delay between the reference voltage AVDD generated by the capacitors and the sub-reference voltages VREFU_H, VREFU_L, VREFL_H and VREFL_L may be compensated for by the output of the first switching unit 320 during a specific time, and instability of the reference voltage AVDD may be compensated for by the output of the second switching unit 330.

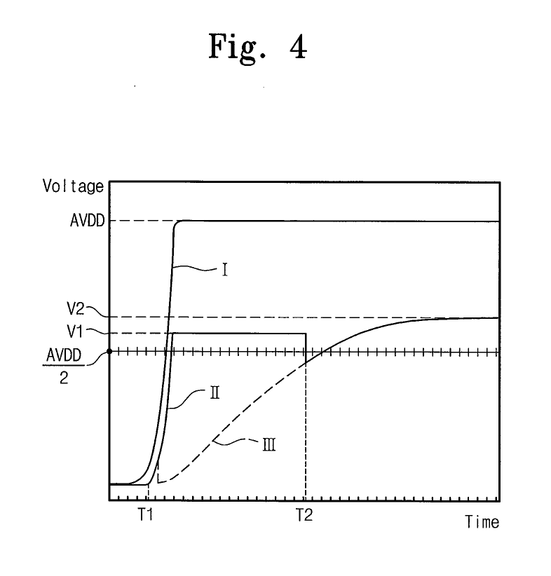

FIG. 4 is a graph illustrating various embodiments of waveforms of the third gamma voltage output from the voltage setting unit, as shown in reference to FIG. 3 and in accordance with the present disclosure. Referring to FIG. 4, a voltage waveform I represents a voltage waveform of the reference voltage AVDD output from the voltage generator 150, as shown in FIG. 1, a voltage waveform II represents a voltage waveform of the third gamma voltage according to the present disclosure, and a voltage waveform III represents a voltage waveform of the conventional gamma voltage. The voltage waveforms II and III of the third gamma voltage, as shown in FIG. 4, represent the third gamma voltage OUT_REFU_L of the third gamma voltages OUT_REFU_H, OUT_REFU_L, OUT_REFL_H and OUT_REFL_L.

Referring to FIG. 4, at the time point Ti, the first switching unit 320 included in the voltage setting unit 240 is turned on in response to the control signal “enb_h” having the high level output from the level shifter 350, and the second switching unit 330 is turned off in response to the control signal “en-h” having the high level output from the level shifter 350. Since the high level of the control signal “enb_h” is maintained until the time point T2 (predetermined time), the turn-on operation of the first switching unit 320 is maintained from the time point T1 to the time point T2.

Thus, in one aspect, after the reference voltage AVDD is boosted to voltage V1 having a predetermined level, which is obtained through voltage division, by the resistor array 310, the voltage V1 having the predetermined level is output through the first output terminal N1 as the third gamma voltage OUT_REFU_L until the predetermined time T2. The voltage V1 having the predetermined level is designed such that the voltage V1 has a level approximate to the target voltage of the third gamma voltage OUT_REFU_L, which is set by a system designer.

Thus, in another aspect, the voltage V1 having the predetermined level may be designed such that the voltage V1 has a level greater than or smaller than that of a target voltage V2 of the third gamma voltage OUT_REFU_L. As such, the voltage V1 having the predetermined level may be designed such that the voltage V1 has the same level as that of the target voltage V2 of the third gamma voltage OUT_REFU_L. FIG. 4 shows that the target voltage V2 of the third gamma voltage OUT_REFU_L has a level greater than that of the voltage V1 having the predetermined level.

After the predetermined time (time point T2), the first switching unit 320 connected to the resist unit 310 shown in FIG. 3 is turned off, and the second switching unit 330 is turned on so that the sub-reference voltage VREF_L is output through the first output terminal N1 as the third gamma voltage OUT_REFU_L.

As a result, during the predetermined time (from the time point T1 to the time point T2), the voltage V1 having the predetermined level that is divided from the reference voltage AVDD is output through the first output terminal N1 as the third gamma voltage OUT_REFU_L. After the predetermined time (time point T2), the sub-reference voltage VREF_L is output through the first output terminal N1 as the third gamma voltage OUT_REFU_L.

Differently from the voltage waveform III of the conventional third gamma voltage, which gradually increases up to the level of the target voltage from the time point T1 to the time point T2, the sub-reference voltage VREF_L is applied to the first output terminal N1 after the time point T2 in a state in which the reference voltage AVDD is boosted to the voltage V1 having the predetermined level, so that time required when the third gamma voltage OUT_REFU_L reaches the target voltage V2 may be shortened. Referring to this embodiment, two sub-reference voltages of the four sub-reference voltages are controlled by the switching controller. However, the scope of the present disclosure is not limited thereto. In one aspect, the four sub-reference voltages may be controlled by the switching controller.

Although the exemplary embodiments of the present disclosure have been described, it is understood that the present disclosure should not be limited to these exemplary embodiments but various changes and modifications may be made by one ordinary skilled in the art within the spirit and scope of the present disclosure, as hereinafter claimed.

What is claimed is:

1. A display apparatus comprising:
a data receiver adapted to receive digital reference data and reference data clocks, the digital reference data serving as a reference of gamma voltages;
a plurality of registers adapted to store the digital reference data received in the data receiver;
a digital-analog converter adapted to convert the digital reference data stored in the registers to analog-type first and second gamma voltages to output the analog-type first and second gamma voltages; and
a voltage setting unit adapted to receive sub-reference voltages to output third gamma voltages,
wherein the voltage setting unit selectively outputs the received sub-reference voltages having a predetermined level.

2. The display apparatus of claim 1, further comprising a sub-reference voltage generator adapted to generate the sub-reference voltages by receiving a reference voltage,
wherein the sub-reference voltage generator comprises:
a plurality of first resistors serially connected between the reference voltage and a ground voltage; and
a plurality of capacitors aligned in a row between a plurality of connection nodes, which connect the first resistors to each other and the ground voltage.

3. The display apparatus of claim 2, wherein the voltage setting unit comprises:
a counter adapted to count a number of the reference data clocks to output a counting value based on the counted number;
a switching controller adapted to output a control signal based on the counting value;
a resistor array having a plurality of second resistors serially connected between the reference voltage and the ground voltage;
a first switching unit adapted to control an electrical connection between at least one connection node that connects the second resistors to each other and an output terminal of the voltage setting unit based on a logic state of the control signal; and
a second switching unit adapted to control an electrical connection between one sub-reference voltage and the output terminal of the voltage setting unit based on the logic state of the control signal.

4. The display apparatus of claim 3, wherein the control signal comprises a voltage, and the voltage setting unit further comprises a level shifter that increases a voltage level of the control signal output from the switching controller.

5. The display apparatus of claim 3, wherein the switching controller outputs a first control signal that turns on the first switching unit and turns off the second switching unit when the counting value is less than a predetermined value, and wherein the switching controller outputs a second control signal that turns off the first switching unit and turns on the second switching unit when the counting value is greater than the predetermined value.

6. The display apparatus of claim 3, wherein a voltage output through the first switching unit comprises a level identical to a level of a voltage output through the second switching unit connected to the output terminal to which the first switching unit is connected.

7. The display apparatus of claim 3, wherein the first gamma voltages are symmetrical to the second gamma voltages about a specific voltage.

8. The display apparatus of claim 3, wherein the third gamma voltages comprise first to fourth voltages, the first voltage being greater than the first gamma voltage having a highest level in the first gamma voltages, the second voltage being smaller than the first gamma voltage having a lowest level in the first gamma voltages, the third voltage being greater than the second gamma voltage having a highest level in the second gamma voltages, and the fourth voltage being smaller than the second gamma voltage having a lowest level in the second gamma voltages.

9. A display apparatus comprising:
a controller adapted to generate image data and a data clock to drive a display unit based on received data and one or more received control signals received from an external source;
a data driver providing an image data signal to a data interconnection provided in the display unit;
a gate driver providing a gate signal to a gate interconnection provided in the display unit; and
a gamma voltage generator generating gamma voltages to provide to the data driver,
wherein the gamma voltage generator selectively outputs sub-reference voltages, which are divided from an external reference voltage, and a specific voltage, which is generated from the gamma voltage generator, as the gamma voltages.

10. The display apparatus of claim 9, wherein the gamma voltage generator comprises:
a data receiver adapted to receive digital reference data and reference data clocks, the digital reference data serving as a reference of gamma voltages and reference data clocks;
a plurality of registers adapted to store the reference data received in the data receiver;
a digital-analog converter adapted to convert the reference data stored in the resistor array to analog-type first and second gamma voltages to output the analog-type first and second gamma voltages; and
a voltage setting unit adapted to receive sub-reference voltages to output third gamma voltages,
wherein the voltage setting unit selectively outputs the received sub-reference voltages having a predetermined level.

11. The display apparatus of claim 10, wherein the voltage setting unit comprises:
a counter adapted to count a number of the reference data clocks;
a resistor array having a plurality of resistors serially connected between a reference voltage and a ground voltage;
a first switching unit having a first end, which is connected to one connection node connecting the resistors in he resistor array to each other, and a second end connected to an output terminal of the voltage setting unit, the first end being opposite to the second end;
a second switching unit having a first end connected to the sub-reference voltage, and a second end connected to the output terminal of the voltage setting unit, the first end being opposite to the second end; and
a switching controller adapted to output control signals, which are used to control the first and second switching units, by receiving a counting value output from the counter.

12. The display apparatus of claim 11, further comprising a level shifter that increases a voltage level of the control signal output from the switching controller.
